(19) United States
(12) Patent Application Publication
(10) Pub. No.: US 2008/0134973 A1
(43) Pub. Date: Jun. 12, 2008

(54) Position adjusting apparatus, sputtering system

(75) Inventors: Susumu Ohtsuka, Higashine (JP); Katsunori Takahashi, Higashine (JP); Hiroshi Akiba, Higashine (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/987,692

(22) Filed: Dec. 4, 2007

(30) Foreign Application Priority Data
Dec. 6, 2006 (JP) 2006-329892

(51) Int. Cl. B05C 13/02

(52) U.S. Cl. 118/713; 118/712

(57) ABSTRACT

A position adjusting apparatus adjusts a mounting position in mounting a substrate on a substrate holder within a sputtering system by a vacuum robot. The position adjusting apparatus has a memory for storing information on the mounting position, driving unit for mounting the substrate on the substrate holder by the vacuum robot on the basis of the stored information on the mounting position, measuring unit for measuring a mounted state of the mounted substrate, judging unit for judging whether or not displacement has occurred on the basis of the measured result and correcting unit for correcting the information on the position for mounting the substrate when it is judged that displacement has occurred.

### BACKGROUND OF THE INVENTION

1. Field of the Invention

The present invention relates to a technology for manufacturing magnetic recording substrates in a sputtering process.

2. Description of the Related Art

A magnetic recording substrate is manufactured through a plurality of manufacturing steps. A procedure of sputtering steps for manufacturing the magnetic recording substrate is carried out as follow. First, prior to sputtering, a substrate that has been subjected to a previous step is mounted on a substrate holder within a sputtering system by means of a vacuum robot. Next, it is subjected to a sputtering process within the sputtering system. Then, after finishing the sputtering, the substrate is taken out of the substrate holder by the vacuum robot to be subjected to a next step. In positional adjustment of the substrate to be mounted to the substrate holder within the sputtering system by the vacuum robot, a feed pulse of each motion axis of the vacuum robot is altered to align the substrate in the X-axis, Z-axis and θ-axis directions by visual confirmation so that the substrate is aligned with the center of the substrate holder. The X-axis direction denotes a vertical direction with respect to the substrate holder, the Z-axis direction denotes a height direction with respect to the substrate holder and the θ-axis direction denotes a horizontal direction with respect to the substrate holder.

Accuracy of the adjustment performed by the vacuum robot depends on the degree of skill of a person who performs visual confirmation in this method. Therefore, displacement occurs every time the vacuum robot is adjusted, destabilizing the position for which adjustment has been completed. That is, when the adjusted position of the vacuum robot is displaced, rubbing occurs between the substrate and claws of the substrate holder that hold the substrate. Meanwhile, sputtering particles are deposited at the claw portion of the substrate holder that holds the substrate due to sputtering. Therefore, when a new substrate rubs the substrate holder due to the displacement in mounting the substrate on such a substrate holder in which the sputtering particles have been deposited on the claws, particles (sputtering particles) scraped from the substrate holder due to rubbing become dust which adheres to the surface of the substrate. These small particles may cause a failure in writing/reading data to/from the magnetic recording substrate.

### SUMMARY

A position adjusting apparatus of the present invention is a position adjusting apparatus for adjusting a mounting position in mounting a substrate on a substrate holder within a sputtering system by a vacuum robot. A position adjusting apparatus has a memory for storing information on the mounting position, means for mounting the substrate on the substrate holder by the vacuum robot on the basis of the stored information on the mounting position, means for measuring a mounted state of the mounted substrate, means for judging whether or not displacement has occurred on the basis of the measured result and means for correcting the information on the position for mounting the substrate when it is judged that displacement has occurred.

### BRIEF DESCRIPTION OF THE DRAWINGS

FIG. 1 is an explanatory diagram of a sputtering system;

FIG. 2 is a diagram showing a configuration of a position adjusting apparatus;

FIG. 3 is an explanatory diagram of a vacuum robot;

FIGS. 4A to 4E are an explanatory diagram in mounting a substrate on a substrate holder;

FIG. 5 shows a method for measuring particles on the substrate;

FIG. 6 shows a process for measuring the particles on the substrate;

FIG. 7 shows a method for measuring the flied particles;

FIG. 8 shows a process for measuring the flied particles;

FIGS. 9A and 9B show a measuring method for adjustment of position through an image monitor;

FIG. 10 shows a process for measuring through the image monitor; and

FIGS. 11A and 11B are an explanatory diagram of displacement.

### DESCRIPTION OF THE PREFERRED EMBODIMENTS

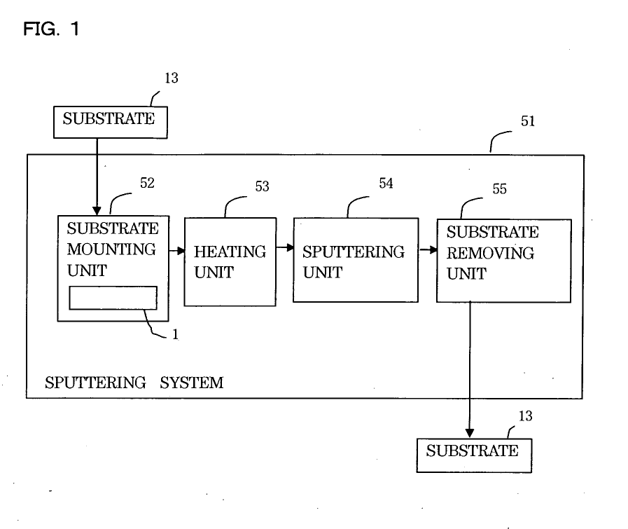

FIG. 1 is an explanatory diagram of a sputtering system. In a sputtering step of a magnetic recording medium, a substrate 13 that has been subjected to a previous step before sputtering is mounted to a substrate holder 11 in a substrate mounting unit 52 within a sputtering system 51 at first. Then, the substrate 13 is subjected to a sputtering process within the sputtering system 51. First, the substrate 13 is heated in a heating unit 53. Next, a plurality of layers of metal is formed on the substrate 13 in a sputtering unit 54 and a DLC (Diamond Like Carbon) film is generated thereon. After sputtering, the substrate 13 on which the films have been formed is taken out of the substrate holder 11 in a substrate removing unit 55 to be subjected to a next step. A vacuum robot 2 mounts and takes out the substrate 13. A position adjusting apparatus 1 for adjusting the position of the substrate 13 mounted on the substrate holder 11 by the vacuum robot 2 is mounted on the substrate mounting unit 52.

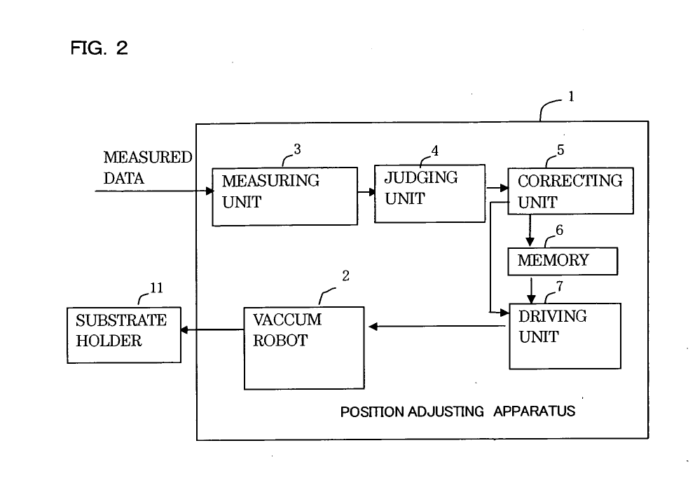

FIG. 2 is a diagram showing a configuration of the position adjusting apparatus. The position adjusting apparatus 1 has the vacuum robot 2, a measuring unit 3, a judging unit 4, a correcting unit 5, a memory 6 and a driving unit 7. The vacuum robot 2 holds the substrate to move it in the X-axis, Z-axis and θ axis directions.

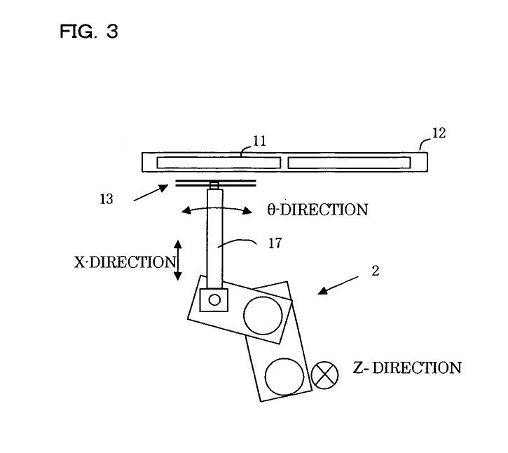

FIG. 3 is an explanatory diagram of the vacuum robot. The vacuum robot 2 has the X-axis in the direction in which the vacuum robot 2 moves the substrate in the vertical direction with respect to the substrate holder 11, the θ axis in the direction in which the vacuum robot 2 moves in the horizontal direction, i.e., to left or right, with respect to the substrate holder 11 seen in a front side and the Z-axis in the direction in which the vacuum robot 2 moves the substrate in the height direction with respect to the substrate holder 11. The vacuum robot 2 also holds the substrate 13 by an end of a hand 17. A carrier 12 holds two sets of the substrate holder 11. The carrier 12 carries the substrate 13 within the sputtering system 51.

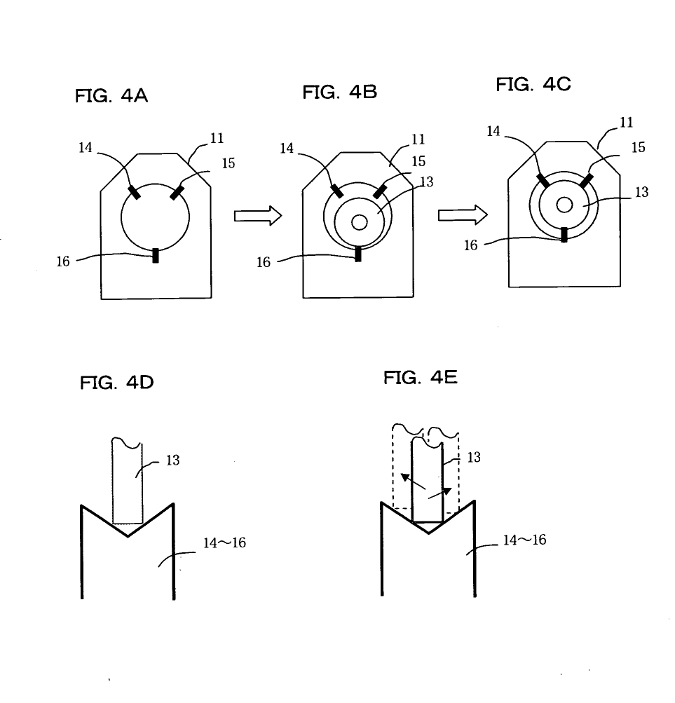

FIGS. 4A TO 4E are an explanatory diagram in mounting the substrate on the substrate holder. The vacuum robot 2 mounts the substrate 13 as follows. At first, the sputtering system 51 presses down a lever placed in a close proximity to the substrate holder 11 to press down a lower claw 16 of the substrate holder 11. Then, the vacuum robot 2 moves the substrate 13 on the hand 17 of the vacuum robot 2 to the substrate holder 11 in the X-axis direction to a space widened by pressing down the claw (see FIG. 4A). When the move is completed, the sputtering system 51 raises the lever and releases the lower claw 16, lifting the lower claw 16 (see FIG. 4B). As a result, the lower claw 16 lifts up the substrate 13 and the substrate 13 touches the upper claws 14 and 15. The substrate 13 is held at position where spring forces of the upper and lower claws 14 through 16 are balanced (see FIG. 4C). The upper and lower claws 14 through 16 have a shape of V to hold the substrate 13. FIG. 4D shows a state in which there is no displacement. Meanwhile, particles 24 are deposited on the upper and lower claws 14 through 16. Therefore, when the substrate 13 is mounted on the substrate holder 11 while being displaced on the faces of V in directions of arrows, the substrate 13 causes rubbing because it slips to the center of bottom of the shape V on the faces of the shape V, thus generating the particles 24 (see FIG. 4E).

Returning to the explanation of FIG. 2, the measuring unit 3 measures the state when the substrate 13 is mounted on the substrate holder 11. As its measuring method, there are three types of methods of measuring the particles 24 adhering to the substrate 13, measuring the flied particles 24 and measuring images of substrate mounting position. These may be used individually or in combinations. The judging unit 4 judges positions where the substrate 13 collides with the upper claws 14 and 15 and the lower claw 16. The correcting unit 5 determines directions to be corrected in accordance to an estimated position and stores preset values corresponding to predetermined correction values. The memory 6 stores the preset values as initial values of the driving unit 7, the corrected preset values and reference edge information in measuring by the images. The driving unit 7 drives and controls the vacuum robot 2. The driving unit 7 sends driving pulses for moving the substrate in the X-axis, θ-axis and Z-axis directions to the vacuum robot 2 in accordance to the preset values of the initial values stored in the memory 6. Then, receiving a signal of completion of correction from the correcting unit 5, the driving unit 7 obtains the preset values from the memory 6. Then, the driving unit 7 sends the driving pulses following the preset values whose initial values have been corrected to the vacuum robot 2. A method for measuring position for accurately setting the substrate 13 to the substrate holder 11 by such a vacuum robot 2 within the sputtering system 51 will be explained below.

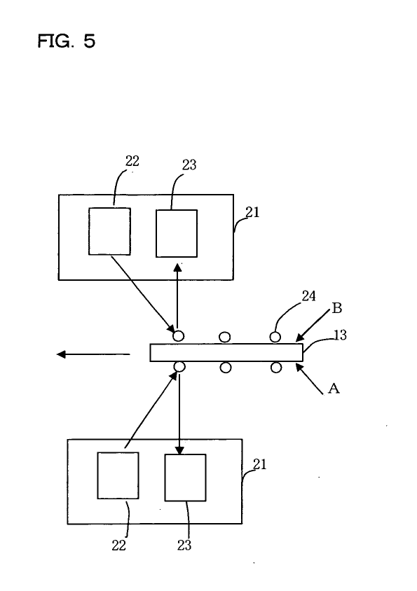

FIG. 5 shows a method for measuring particles on the substrate. The particles 24 on the substrate 13 will be measured by using measuring devices A21. The measurement is carried out by setting the two measuring devices A21 on the both sides of the substrate 13. The whole surfaces of the substrate 13 may be measured by moving the substrate 13 in a predetermined direction. The measuring device A 21 has a laser-emitting unit 22 and a light-receiving unit 23. The laser-emitting unit 22 emits laser and the light receiving unit 23 detects the light reflected and scattered by the particles 24. It can measure within or without the sputtering system 51. In measuring on the outside of the sputtering system 51, an investigative substrate 13 is discharged out of the sputtering system 51 to place at a predetermined measuring place after turning around one time without activating sputtering within the sputtering system 51.

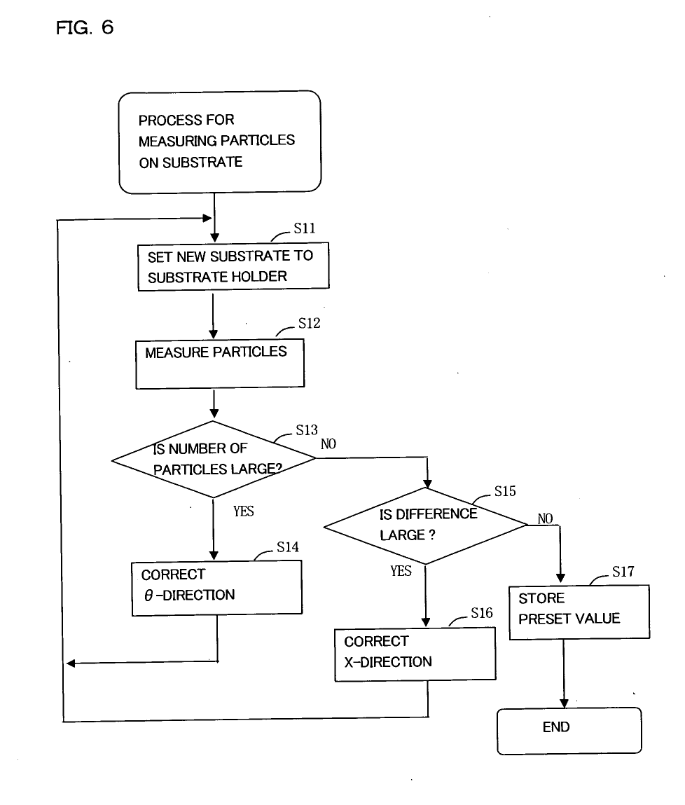

FIG. 6 shows a process for measuring the particles on the substrate. A new investigative substrate 13 is set on the substrate holder 11 (Step S11). Values of the driving pulses in the X-axis, θ-axis and Z-axis directions at this time are set by obtaining the preset values from the memory 6. The preset values are initial values in the beginning in starting the measurement. Next, the particles 24 on the surface of the substrate 13 are measured (Step S12). The measurement of number and size of the particles 24 adhering on the surface of the substrate 13 is carried out by emitting laser to the surface of the substrate 13 and by detecting its scattered light. This measurement is carried out on the both sides of the substrate 13. Then, it is judged whether or not an absolute value of the particles 24 on the both sides of the substrate 13 is large. (Step S13). If the number of the particles 24 exceeds a predetermined number, it is judged that the absolute value is large. When the absolute value is large, it is estimated to be a gap of the substrate 13 in the θ direction and is corrected by a predetermined value (Step S14). The correction is made in a sequence of moving the substrate to the left for example with respect to the substrate holder 11 at first and when no improvement is made, of moving it to the right. It is because the rubbing may be occurring due to displacement of the position for mounting the substrate 13 in the right or left direction by a predetermined value when seen from the vacuum robot 2. That is, scraping of the particles 24 on the lower claw 16 and on the upper claw 14 or 15 may occur by the substrate 13 and the particles 24 may adhere to the both sides of the substrate. When the absolute value of the particles 24 on the substrate 13 is not large on the both sides, a difference between the surfaces is checked (Step S 15). When the difference between the surfaces is large, there may be a gap in the X-axis direction, so that it is corrected by a predetermined value so that the difference becomes small (Step S16). If the surface where the absolute value of the particles 24 is large is an A face side (the side of the vacuum robot 2), a value of the X-axis is increased. It is because rubbing may be occurring due to displacement of the position for mounting the substrate 13 to the front side from the predetermined value when seen from the vacuum robot 2. That is, it is because the scraping of the particles 24 of the upper and lower claws 14 through 16 by the substrate 13 may occur on the front side and the particles may adhere to the substrate. If the surface where the absolute value of the particles 24 is large is a B face side (opposite face from the A face), the value in the X-axis direction is decreased. It is because the rubbing may be occurring due to displacement of the position for mounting the substrate 13 to the depth side from the predetermined value when seen from the vacuum robot 2. That is, it is because the scraping of the particles 24 of the upper and lower claws 14 through 16 by the substrate 13 may be occurring in the depth side and the particles may adhere to the substrate. When the absolute value is small on the both side, and there is no difference between the surfaces, the preset values are stored in the memory 6 (Step S17).

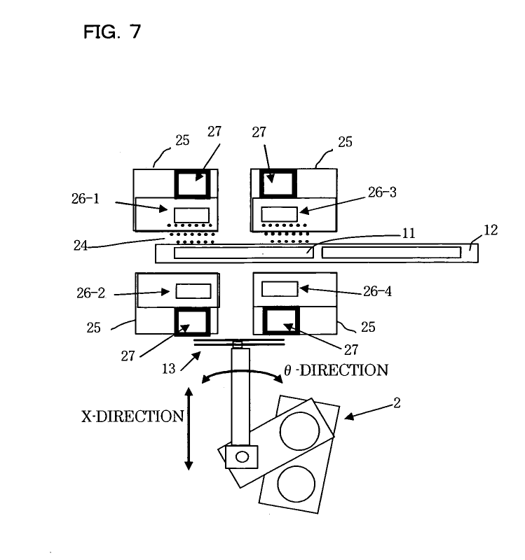

FIG. 7 shows a method for measuring the flied particles. A measuring device B 25 for measuring the flied particles has a sensor 26 and a magnet 27. The measuring devices B 25 are set within the sputtering system 51 so that the sensors 26-1 through 26-4 are placed on the both sides of the substrate holder 11 for mounting the substrate 13 to be measured. Still more, the adsorption magnets 27 are placed in the vicinity of the sensors 26 to increase sensitivity of the sensors 26 for detecting the particles. The sensor 26 has the laser emitting unit 22 and the light-receiving unit 23.

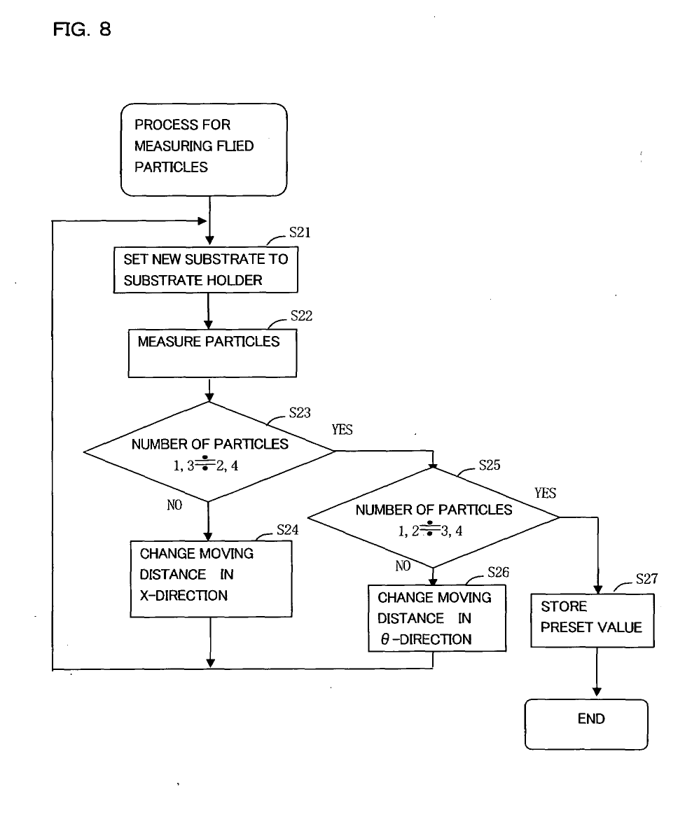

FIG. 8 shows a process for measuring the flied particles. The substrate 13 is set on the substrate holder 11 by the vacuum robot 2 (Step S21). Next, a number of flied particles are measured. The measurement is carried out by counting the number of flied particles per unit time (per 1 sec. in minimum) by the sensor 26 (Step S22). Then, it is judged whether or not the results of the measured number of flied particles in mounting the substrate is almost equal between the sensors 26-1 and 26-3 and the sensors 26-2 and 26-4 (Step S23). When they are not almost equal, a moving distance of the vacuum robot 2 in the X direction is changed (Step S24). Specifically, when the results of the sensors 26-1 and 26-3 are greater than those of the sensors 26-2 and 26-4, the position for mounting the substrate 13 is leaned toward the depth side (to the upper side in FIG. 7), causing the scraping between the substrate 13 and the upper and lower claws 14 through 16, so that the move of the robot is corrected by a predetermined value in the direction such that the moving distance of the vacuum robot 2 in the X direction is shortened, i.e., to the front side (in the lower direction in FIG. 7). When the results of the sensors 26-1 and 26-3 are smaller than those of the sensors 26-2 and 26-4, the position for mounting the substrate 13 is leaned toward the front side (to the lower side in FIG. 7), causing the scraping between the substrate 13 and the upper and lower claws 14 through 16, so that the move of the vacuum robot 2 is corrected by a predetermined value in the direction such that the moving distance of the vacuum robot 2 in the X direction is prolonged, i.e., to the front side (in the upper direction in FIG. 7). The process returns to Step S21 to measure again by a new substrate. When results of measurement of flied particles of the sensors 26-1 and 26-3 are almost equal to those of the sensors 26-2 and 26-4, it is judged whether or not the results are almost equal between the sensors 26-1 and 26-2 and the sensors 26-3 and 26-4 (Step S25). When they are not almost equal, the moving distance of the vacuum robot 2 in the θ direction is changed (Step S26).

Specifically, when the results of the sensors 26-1 and 26-2 are greater than those of the sensors 26-3 and 26-4, the position for mounting the substrate 13 is leaned toward the left, causing the scraping of the substrate 13 between the upper claw 14 and the lower claw 16, so that the move of the vacuum robot 2 is corrected by a predetermined value such that the θ direction of the vacuum robot 2 is adjusted to the right direction. When results of the sensors 26-1 and 26-2 are smaller than those of the sensors 26-3 and 26-4, the position for mounting the substrate 13 is leaned toward the right, causing the scraping of the substrate 13 between the upper claw 15 and the lower claw 16, so that the move of the vacuum robot 2 is corrected by a predetermined value such that the θ direction of the vacuum robot 2 is adjusted to the left direction. The process returns to Step S21 to measure again by a new substrate 13. When results of measurement of flied particles of the sensors 26-1 and 26-3 become almost equal to those of the sensors 26-2 and 26-4, the preset values are stored in the memory 6 (Step S27).

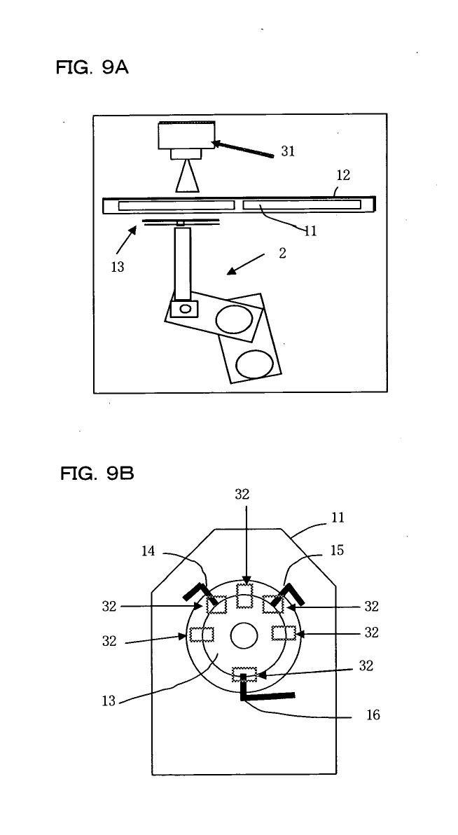

FIGS. 9A and 9B show the measuring method for adjusting the position through an image monitor. An image monitor 31 is installed within the sputtering system 51 at position facing to the substrate holder 11 on the opposite side from the vacuum robot 2 (see FIG. 9A). The image monitor 31 detects positions of six predetermined measuring areas 32 of edge portions of the three upper and lower claws 14 through 16 and of upper and lower and right and left directions of the substrate 13 (see FIG. 9B).

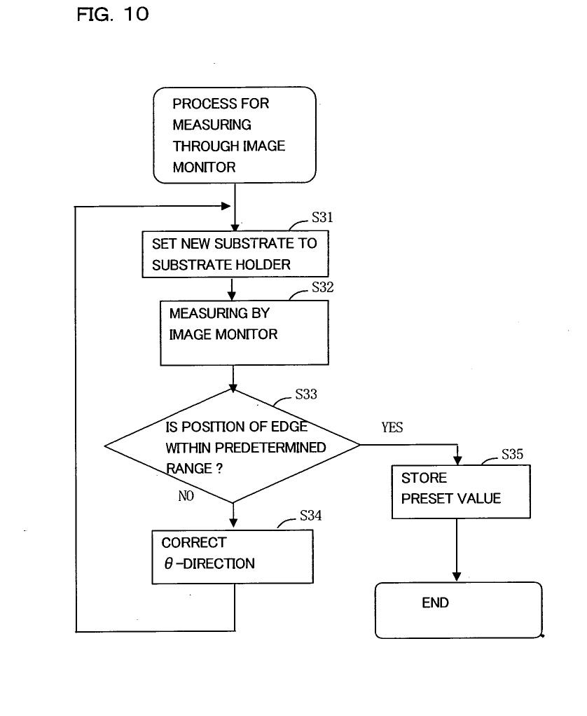

FIG. 10 shows a process for measuring through the image monitor. A new substrate 13 is set on the substrate holder 11 by the vacuum robot 2 (Step S31). It is then measured by the image monitor 31. The measurement is carried out by detecting the edge of each point at timing when the substrate 13 is held by the upper and lower claws 14 through 16 (Step S32). The image monitor 31 judges whether or not the position of the edge falls within a predetermined range (Step S33). When there is a deviation, it is corrected in the θ direction (Step S34). Judgment of the deviation is carried-out as follows. At first, the image monitor 31 obtains an image of the empty substrate holder 11. Then, it sets a center position of the substrate 13 through virtual calculation. Next, it sets an area where the edge is to be detected. The detection of the edge means to find a profile of an object by variations of contrast (white to black or black to white). Then, it sets the edge of each point to be detected in mounting a substrate in advance by calculation. It obtains profile data of the substrate 13 and the upper and lower claws 14 through 16 within a predetermined area. Next, it actually measures. Then, it judges that an edge line indicates which position within the predetermined area or if it is out of the predetermined range.

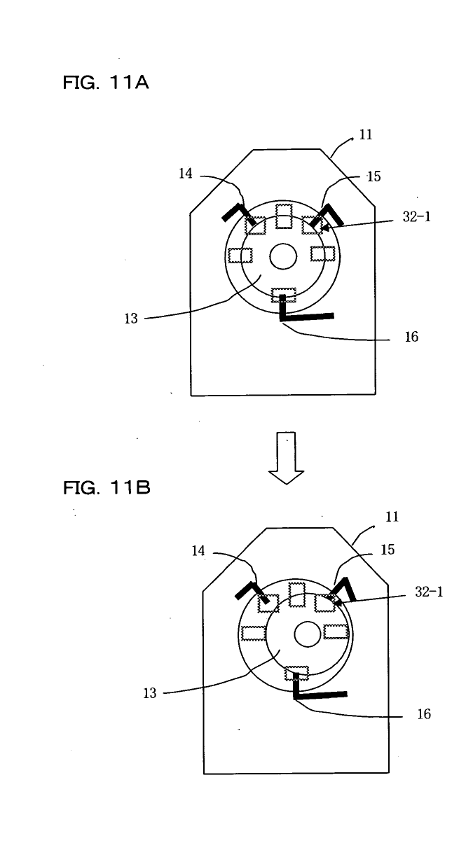

FIGS. 11A and 11B are explanatory diagrams of displacement. For example, FIG. 11A shows a case when the substrate is normally mounted and FIG. 11B shows a case when the substrate is mounted while leaning to the right side. When the position of the substrate 13 is leaned to the right side as a result of detection of the edge, it is judged to be no good because the upper right claw 15 in the measuring area 32-1 is pushed up and a correction of the θ direction is made toward the left. When the position of the substrate 13 is leaned to the left side and the upper left claw 14 is pushed up as a result of detection of the edge, it is judged to be no good and a correction of the θ direction is made toward the right. Then, after deciding the correction value, the process returns to Step S31 to measure again. When the result of detection of each edge falls within a predetermined range and becomes normal, its preset value is stored in the memory 6 (Step S35). However, the image sensor is unable to detect displacement in the X-axis direction. Therefore, the accuracy improves by carrying out the particle measurement or that on the surface of the substrate in combination to detect the displacement in the X direction.

As a result, the substrate is accurately mounted on the substrate holder of the sputtering system, so that an occurrence of particles may be reduced.

What is claimed is:

1. A position adjusting apparatus for adjusting a position for mounting a substrate on a substrate holder within a sputtering system by a vacuum robot, comprising:
a memory for storing position information for mounting the substrate on the substrate holder;
means for driving the vacuum robot for mounting the substrate on the substrate holder on the basis of the stored position information;
means for measuring state of the mounted substrate on the substrate holder;
means for judging displacement of the position of mounted substrate on the substrate holder on the basis of the measured result; and
means for correcting the position information upon the judged displacement.

2. The position adjusting apparatus according to claim 1, wherein the means for measuring measures a number of particles adhered to the substrate when the substrate holder contacts the substrate.

3. The position adjusting apparatus according to claim 1, wherein the means for measuring measures a number of particles made airborne when the substrate holder contacts the substrate.

4. The position adjusting apparatus according to claim 2, wherein the means for judging judges that the substrate is displaced in a horizontal direction with respect to the substrate holder when an absolute value of a number of adhering particles is larger than a predetermined value.

5. The position adjusting apparatus according to claim 2, wherein the means for judging judges that the substrate is displaced in a vertical direction with respect to the substrate holder when a difference of numbers of adhering particles between the surfaces of the substrate is larger than a predetermined value.

6. The position adjusting apparatus according to claim 3, wherein the means for judging judges that judges that the substrate is displaced in a vertical direction with respect to the substrate holder when a difference of numbers of flied particles between the surfaces of the substrate is larger than a predetermined value.

7. The position adjusting apparatus according to claim 3, wherein the means for judging judges that the substrate is displaced in the horizontal direction with respect to the substrate holder when a difference of numbers of flied particles between vicinity of right part of the substrate and vicinity of left part of the substrate is larger than a predetermined value.

8. A position adjusting apparatus for adjusting a mounting position in mounting a substrate on a substrate holder within a sputtering system by a vacuum robot, comprising:
a memory for storing position information for mounting the substrate on the substrate holder;
means for driving the vacuum robot for mounting the substrate on the substrate holder on the basis of the stored position information;
means for inputting images;
means for obtaining a first edge image of a predetermined area on the basis of an image of the substrate holder, said substrate holder mounting no substrate;
means for obtaining a second edge image of the predetermined area on the basis of an image of the substrate holder, said substrate holder mounting the substrate;
means for measuring differences between the first and second edge images;
means for judging displacement of the position of mounted substrate on the substrate holder on the basis of the measured result; and
means for correcting the position information upon the judged displacement.

9. A sputtering system having a heating unit for heating a substrate mounted on a substrate holder by a vacuum robot and a sputtering unit for forming a thin film on the heated substrate, comprising:
a memory for storing position information for mounting the substrate on the substrate holder;
means for driving the vacuum robot for mounting the substrate on the substrate holder on the basis of the stored position information;
means for measuring state of the mounted substrate on the substrate holder;
means for judging displacement of the position of mounted substrate on the substrate holder on the basis of the measured result; and
means for correcting the position information upon the judged displacement.

10. A position adjusting apparatus for adjusting a position for mounting a substrate on a substrate holder within a sputtering system, comprising:
a vacuum robot;
a memory for storing position information for mounting the substrate on the substrate holder;
a driving unit for driving the vacuum robot for mounting the substrate on the substrate holder on the basis of the position information stored in the memory;
a measuring unit for measuring a number of particles corresponding to position on the substrate, said particles being generated upon the substrate being mounted on the substrate holder by the vacuum robot driven by the driving unit;
a judging unit for judging displacement of the position of the substrate mounted on the substrate holder on the basis of the measured number of particles corresponding to the position on the substrate; and
a correcting unit for correcting the position information to correct the judged displacement.

11. A position adjusting apparatus for adjusting a position for mounting a substrate on a substrate holder within a sputtering system, comprising:
a vacuum robot;
a memory for storing position information for mounting the substrate on the substrate holder;
a driving unit for driving the vacuum robot for mounting the substrate on the substrate holder on the basis of the position information stored in the memory;
a measuring unit for obtaining a first edge image of a predetermined area on the basis of an input image of the substrate holder unmounting the substrate and obtaining a second edge image of the predetermined area on the basis of an input image of the substrate holder mounting the substrate, said substrate being mounted by the vacuum robot driven by the driving unit;
a judging unit for judging displacement of the position of the substrate mounted on the substrate holder on the basis of difference between the first edge image and the second edge image; and
a correcting unit for correcting the position information to correct the judged displacement.
